(19) United States
(12) Patent Application Publication
(10) Pub. No.: US 2010/0264190 A1
(43) Pub. Date: Oct. 21, 2010

(54) Effort-saving Stapler

(76) Inventors: Eric Tsai, Tali City (TW); Ching-Li Wang, Tali City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/640,091

(22) Filed: Dec. 17, 2009

(30) Foreign Application Priority Data
Apr. 16, 2009 (TW) 98112663

(51) Int. Cl. B25C 5/11; B25C 5/16

(52) U.S. Cl. 227/128; 227/120

(57) ABSTRACT

An effort-saving stapler comprises a base member defining a coupled member; a magazine assembly having a first end pivotally connected to the coupled member and a second end; a linkage assembly which has a first end and a second end including a pair of first slide grooves defined at the first end thereof, a pair of channels defined at the second end thereof, a pair of second slide grooves defined between the first and second ends thereof and a firing member slideably coupled to the channel and being able to drive the second end of the magazine assembly; a lever arm which has a first end slideably coupled to the first slide grooves of the linkage assembly and a second end including a pair of third slide grooves between the first and second ends thereof, with the second and third slide grooves slideably joined together and selectively engaged with the coupled member of the base assembly, and with the lever arm pivotally coupled to the coupled member between the first end of the lever arm and the third slide grooves.

### BACKGROUND OF THE INVENTION

### Field of the Invention

The present invention relates to a stapler, and more particularly to an effort-saving stapler.

### SUMMARY OF THE INVENTION

Accordingly, the object is achieved by providing an effort-saving stapler. The effort-saving stapler comprises a base member defining a coupled member; a magazine assembly having a first end pivotally connected to the coupled member and a second end; a linkage assembly which has a first end and a second end including a pair of first slide grooves defined at the first end thereof, a pair of channels defined at the second end thereof, a pair of second slide grooves defined between the first and second ends thereof and a firing member slideably coupled to the channels and being able to drive the second end of the magazine assembly; a lever arm which has a first end slideably coupled to the first slide grooves of the linkage assembly and a second end including a pair of third slide grooves between the first and second ends thereof, with the second and third slide grooves slideably joined together and selectively engaged with the coupled member of the base assembly, and with the lever arm pivotally coupled to the coupled member between the first end of the lever arm and the third slide grooves.

Further, several slide grooves of the stapler allows the components of the stapler to be able to slide therealong so that fill of staples into the magazine assembly can be smooth and easy.

Other advantages and features of the present invention will become apparent from the following descriptions referring to the drawings.

### BRIEF DESCRIPTION OF THE DRAWINGS

The present invention will be described through detailed illustration of the preferred embodiment referring to the drawings.

FIG. 1 is a perspective view of an effort-saving stapler according to the preferred embodiment of the present invention.

FIG. 2 is an exploded view of the stapler as shown in FIG. 1.

FIG. 3 is a side view of the stapler as shown in FIG. 1.

FIG. 4 is a cross-sectional view taken along 4-4 in FIG. 1.

FIG. 5 is a cross-sectional view similar to FIG. 4, illustrating the lever arm is pressed downward.

FIG. 6 is a cross-sectional view similar to FIG. 4, illustrating that the stapler is finished to bind papers.

FIG. 7 is a side view of the stapler as shown in FIG. 1, illustrating the lever arm is opened up for preparing to fill staples into the magazine assembly.

FIG. 8 is another side view of the stapler as shown in FIG. 1, illustrating the lever arm drives the linkage assembly to be opened up.

FIG. 9 is yet another side view of the stapler as shown in FIG. 1, illustrating the magazine cover is driven to be opened up.

### DETAILED DESCRIPTION OF THE PREFERRED EMBODIMENT

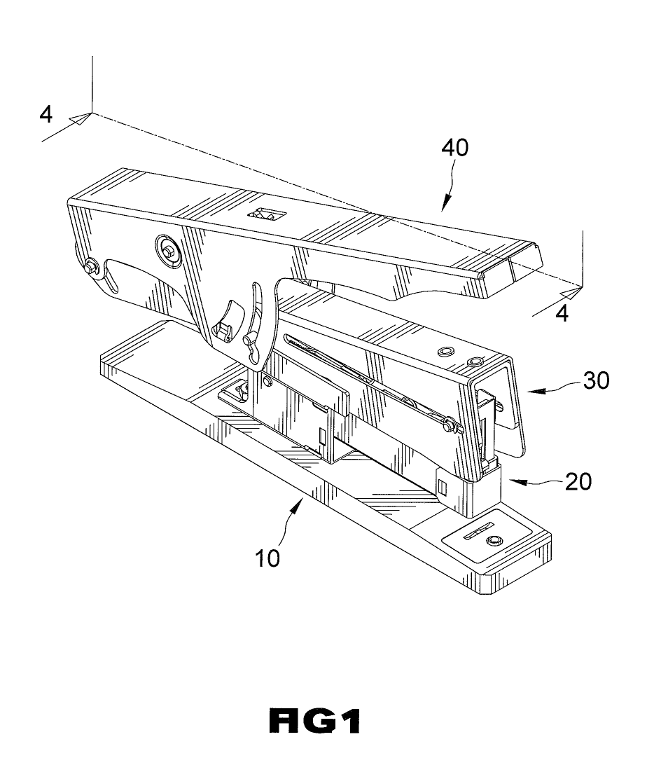

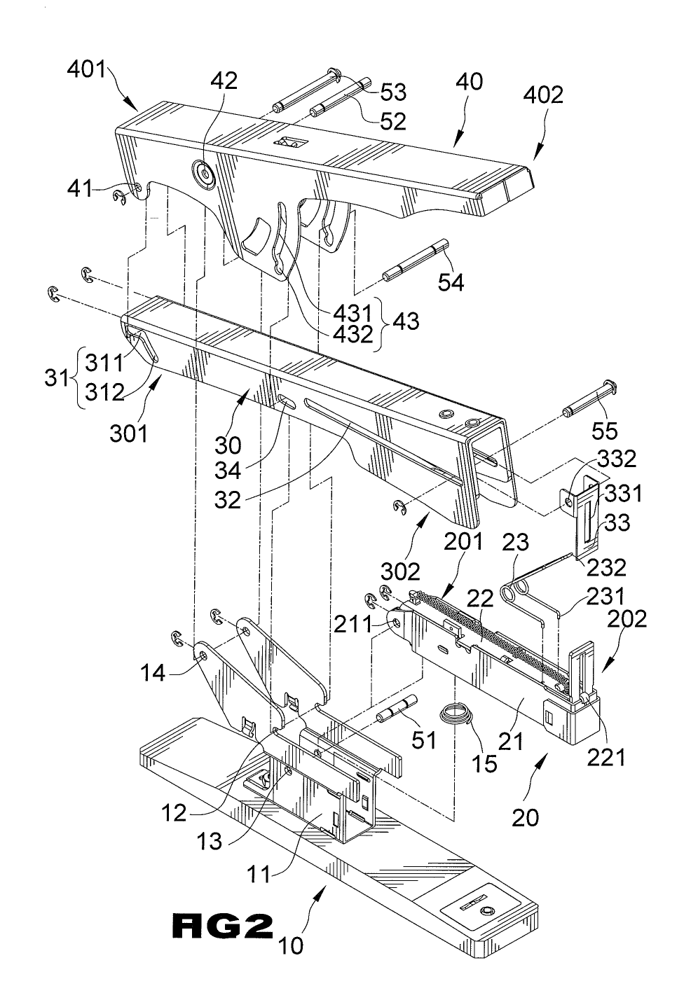

With reference to FIGS. 1 and 2, they show that an effort-saving stapler includes a base assembly 10, a magazine assembly 20, a linkage assembly 30, a lever arm 40 and first, second, third fourth and fifth joint units 51, 52, 53, 54 and 55.

A coupled member 11 which is installed on the base assembly 10 and disposed between two ends of the base assembly 10 consists of two spaced plates (not numbered). A hooked portion 12 and first and second connected holes 13, 14 are defined at the coupled member 11. Horizontal positions of the hooked portion 12 and the first and second connected holes 13, 14 are different from one another, and the horizontal position of the second connected hole 14 is higher than that of the hooked portion which is higher than that of the first connected hole 13. An elastic element 15 which is set inside of the coupled member 11 provides a force to press the magazine assembly 20 upward and cushions a downward force of the magazine assembly 20 during firing staples.

The magazine assembly 20 which includes a shell member 21 and a magazine cover 22 pivotally connected to the shell member 21 has a first end 201 and a second end 202. The shell member 21 forms with an aperture 211 at the first end 201 of the magazine assembly 20. The magazine cover 22 forms with a hook portion 221 at the second end 202 of the magazine assembly 20. An elastic element 23, in this embodiment, is preferably in form of a torque spring and has two first legs 231 and a second leg 232. The two first legs 231 are inserted through the magazine cover 22 into the second end 202 of the magazine assembly 20. The second leg 232 tilts up with respect to the first legs 231 in an original position of the stapler.

The linkage assembly 30 which is made of a bent flake-like sheet metal and forms with a bottom side and two spaced lateral sides has a first end 301 and a second end 302. A pair of first slide grooves 31 is respectively formed on the two lateral sides of the first end 301 of the linkage assembly 30, and each first slide groove 31 is preferably L-shaped and has a first section 311 and a second section 312. Each first section 311 is approximately parallel to a longitudinal direction of the linkage assembly 30 from the first end 301 to the second end 302. A pair of channels 32 is respectively formed on the two lateral sides of the second end 302 of the linkage assembly 30, and each channel 32 is preferably in form of a long slot. A pair of second slide grooves 34 is respectively formed on the two lateral sides of the linkage assembly 30 between the first and second ends 301 and 302. A firing member 33 is coupled to the second end 302 of the linkage assembly 30 and slideably provided along the channels 32 via the fifth joint unit 55. In this embodiment, the firing member 33 is made of a bent sheet metal and defines a first side and two spaced second sides. The second sides of the firing member 33 are respectively perpendicular to the first side of the firing member 33. The second sides of the firing member 33 are respectively abutted against the inner surface of the lateral sides of the linkage assembly 30. A slot 331 is longitudinally formed on the first side of the firing member 33 and two holes 332 are respectively formed on the second sides of the firing member 33. The fifth joint unit 55 is inserted through the channels 32 and the holes 332 for slideably coupling the firing member 33 and the second ends 302 of the linkage assembly 30.

The lever arm 40 consists of two lateral sides and a top side and has a first end 401 and a second end 402. A first coupled orifice 41, a second coupled orifice 42 and a third slide groove 43 are formed on each lateral side of the lever arm 40. The first coupled orifices 41 are adjacent to the first end 401 of the lever arm 40, the third slide grooves 43 are defined between the first and second ends 401, 402 of the lever arm 40 and the second coupled orifices 42 are defined between the first coupled orifices 41 and the third slide grooves 43. Each third slide groove 43 which is slightly arc-shaped and substantially perpendicular to the whole length of the lever arm 40 has a first section 431 adjacent to the top side of the lever arm 40 and a second section 432.

The first connected holes 13 of the base assembly 10 are pivotally coupled to the apertures 211 of the magazine assembly 20 via the first joint unit 51. The second connected holes 14 of the base assembly 10 are pivotally coupled to the second coupled orifices 42 of the lever arm 40 via the second joint unit 52. The first coupled orifices 41 are slideably coupled to the first slide grooves 31 of the linkage assembly 30 via the third joint unit 51. The third slide grooves 43 of the lever arm 40 are slideably coupled to the second slide grooves 34 of the linkage assembly 30 via the fourth joint unit 54 which is selectively engaged with the hooked portion 12 of the base assembly 10.

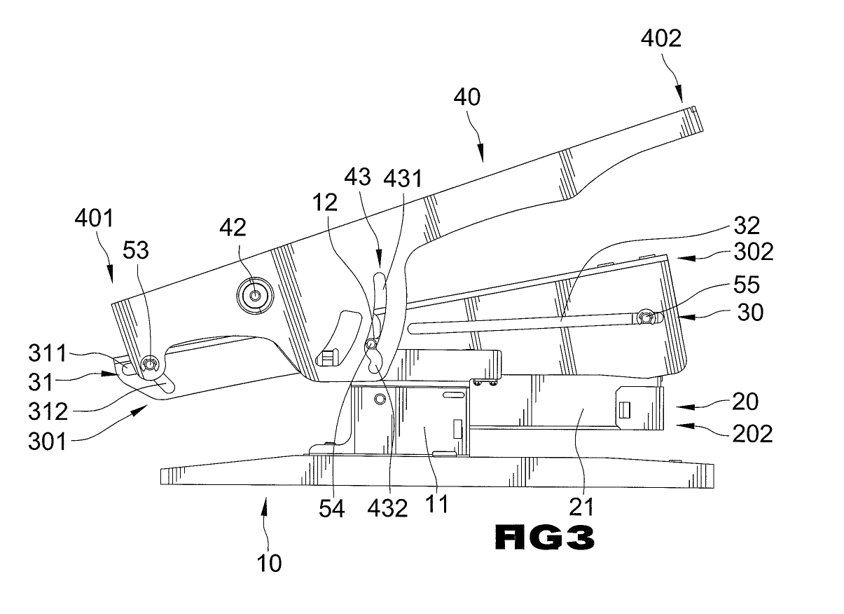

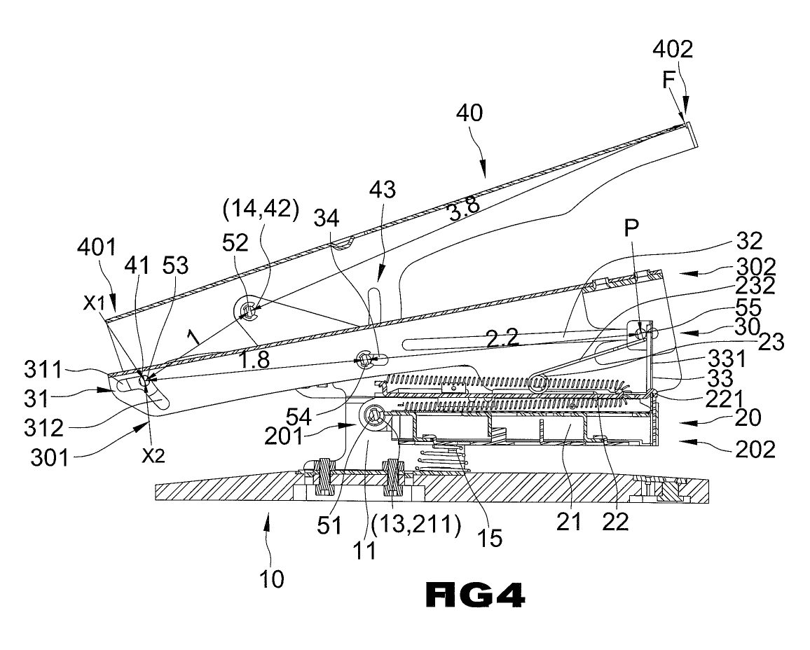

Referring to FIGS. 3 and 4, they show that the stapler of the present invention is in the original position. The elastic element 15 provided at the base assembly 10 is released to press to the bottom of the magazine assembly 20 upward and the elastic element 23 set in the magazine assembly 20 is released to drive the second leg 232 to abut against the fifth joint unit 55 and then, the second end 302 of the linkage assembly 30 is driven to tilt up with respect to the base assembly 10. In the meanwhile, the fourth joint unit 54 is engaged with the second section 432 of the third slide groove 43 and also engaged with the hooked portion 12 of the base member 10. The third joint unit 53 is provided at a connection of the first and second sections 311 and 312 of the first slide groove 31.

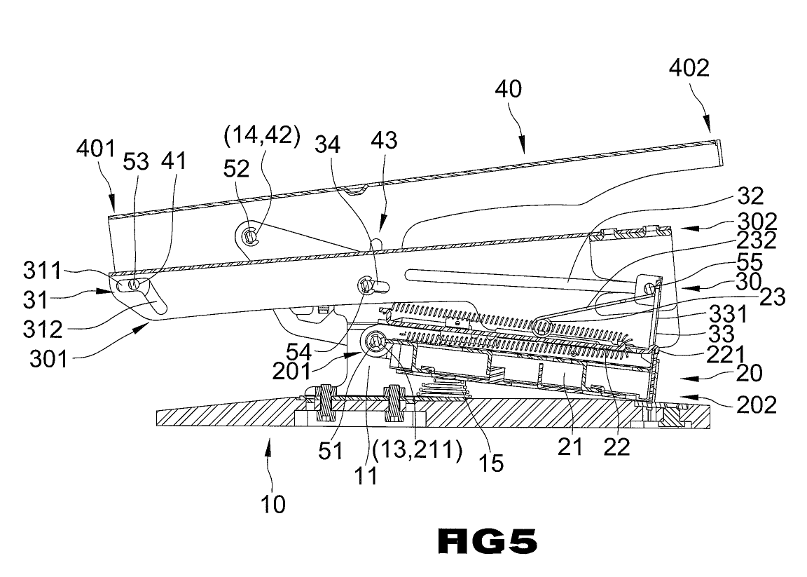

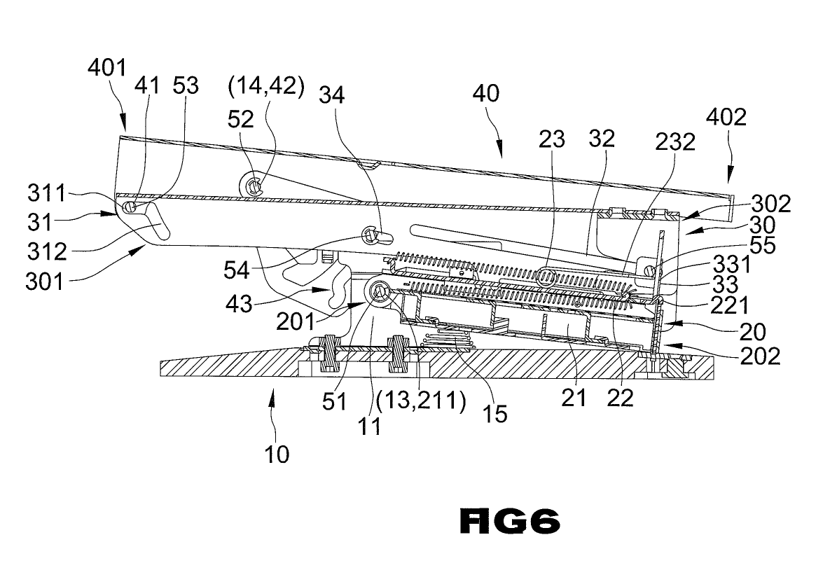

Referring to FIGS. 5 and 6, they show the stapler is being driven to fire staples. The second end 402 of the lever arm 40 is operated to press downward with respect to the base assembly 10 and the lever arm 40 pivots with the second joint unit 52 as a fulcrum downward with respect to the base member 10. The fourth joint unit 54 is driven to slide along the third slide groove 43 of the lever arm 40 during the lever arm 40 pivots with respect to the base member 10, and the third joint unit 53 slides along the first section 311 of the first slide groove 31. The elastic element 15 is pressed downward by the magazine assembly 20. Further, the linkage assembly 30 is driven to press downward by the lever arm 40 and the fifth joint unit 55 presses the elastic element 23 downward to drive the firing member 33 to fire staples.

A ratio of a distance between the first and second coupled orifices 41 and 42 and a distance between the second coupled orifice 42 and the distal end of the second end 402 of the lever arm 40 stands at 1:3.8. A ratio of a distance between the connection of the first and second sections 311 and 312 of the first slide groove 31 and a distal end of the second slide groove 34 adjacent to the first slide groove 31 and a distance between the distal end of the second slide groove 34 adjacent to the first slide groove 31 and a distal end of the channel 32 adjacent to the second end 302 of the linkage assembly 30 stands at 1.8:2.2. A direction from the second coupled orifice 42 to the first coupled orifice 41 defines an angle of 25 degrees with respect to a direction from the connection of the first and second sections 311 and 312 of the first slide groove 31 to the distal end of the second slide groove 34 adjacent to the first slide groove 31.

While applying a force F to the second end 402 of the lever arm 40 to fire staples, a force X1 will be applied at the connection of the first and second sections 311 and 312 of the first slide groove 31 to which the third joint unit 53 is inserted. The value of the force X1 can be calculated by the following formula:

F*3.8=X1*1

X1=3.8F

Because the direction from the second coupled orifice 42 to the first coupled orifice 41 and the direction from the connection of the first and second sections 311 and 312 of the first slide groove 31 to the distal end of the second slide groove 34 adjacent to the first slide groove 31 define the 25 degrees angle, a force loss is generated during the force X1 is transmitted to a reacting force X2 which is applied at the connection of the first and second sections 311 and 312 of the first slide groove 31 to which the third joint unit 53 is inserted. The value of the reacting force X2 can be calculated by the following formula:

X2=X1*cos 25°=3.8F*0.906=3.4428F

There's a value difference between the force X1 and the reacting force X2 and the value difference can be calculated by the following formula:

X2−X1=3.8F−3.4428F=0.5572F

A firing force P is generated at the fifth joint unit 55 which is coupled to the firing member 33. The value of the force P can be calculated by the following formula:

X2*1.8=P*2.2

3.4428F*1.8=2.2P

P=2.8F

In conclusion, the second end 402 of the lever arm 40 is applied to the force F and during the force transmission, the firing member 33 will be applied to the force P for firing staples and the force P is 2.8 times as larger as the force F. It can achieve an effort-saving effect.

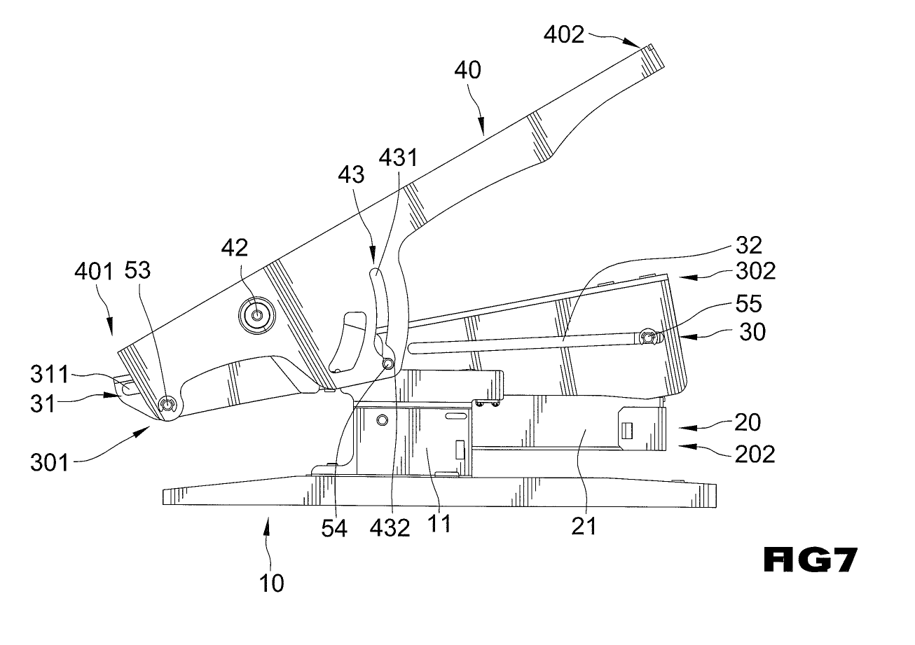

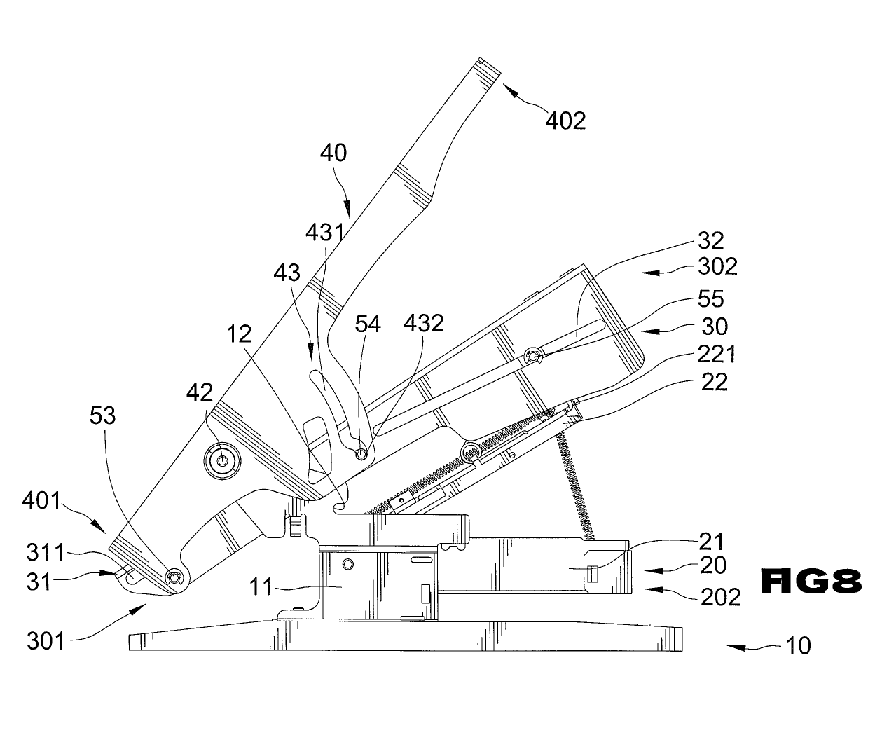

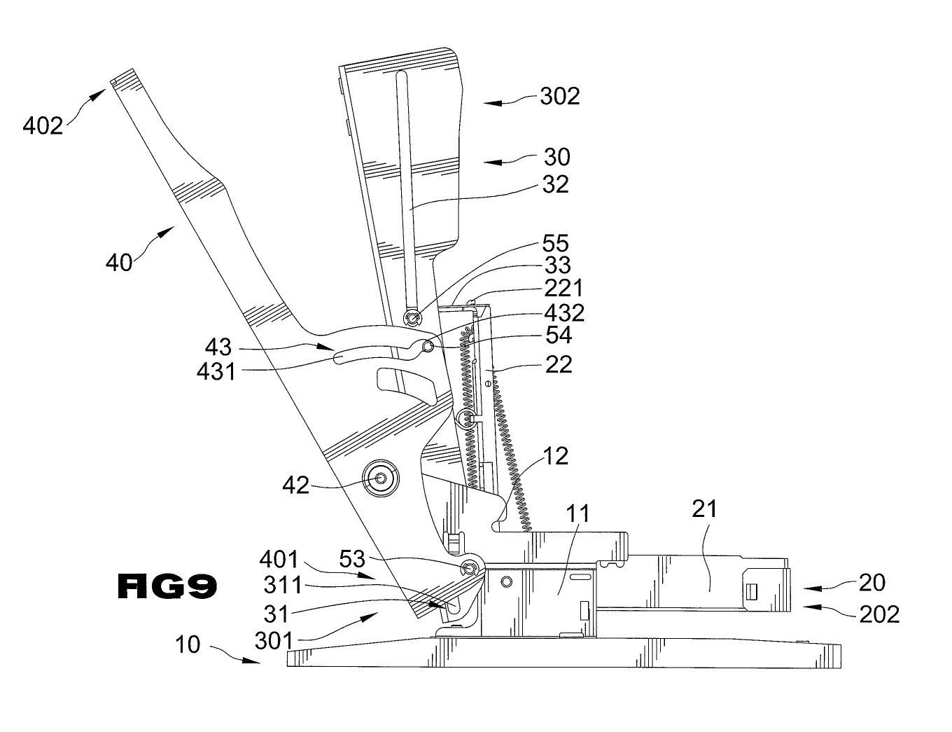

Referring to FIGS. 7 through 9, they show fill of staples into the magazine assembly 20 of the stapler. The lever arm 40 is operated to pivot with the third joint unit 53 as a fulcrum upward with respect to the linkage assembly 30. During the lever arm 40 is being pivoting, the first end 401 of the lever arm 40 drives the third joint unit 53 to move along the second section 312 of the first slide groove 31 (as shown in FIG. 3) and the fourth joint unit 54 is driven to move to the second section 432 of the third slide groove 43. Then, the lever arm 40 and the linkage assembly 30 are opened upward and the hook portion 221 of the magazine cover 22 is hooked to the slot 331 of the firing member 33 (as shown in FIG. 2) as to drive the magazine cover 22 to be opened by the linkage assembly 30 upward with respect to the shell member 21. Therefore, users can fill staples into the magazine assembly 20 smoothly.

While several embodiments of the invention have been shown and described, it will be apparent to those skilled in the art that modifications may be made therein without departing from the scope and spirit of the present invention.

What is claimed is:

1. An effort-saving stapler comprising:
a base member defining a coupled member;
a magazine assembly having a first end pivotally connected to the coupled member and a second end;
a linkage assembly which has a first end and a second end including a pair of first slide grooves defined at the first end thereof, a pair of channels defined at the second end thereof, a pair of second slide grooves defined between the first and second ends thereof and a firing member slideably coupled to the channels and being able to drive the second end of the magazine assembly;
a lever arm which has a first end slideably coupled to the first slide grooves of the linkage assembly and a second end including a third slide grooves between the first and second ends thereof, with the second and third slide grooves slideably joined together and selectively engaged with the coupled member of the base assembly, and with the lever arm pivotally coupled to the coupled member between the first end of the lever arm and the third slide grooves;
wherein a distance between the first end of the lever arm and a joint of the lever arm and the coupled member of the base assembly is smaller than a distance between the joint of the lever arm and the coupled member of the base assembly and the second end of the lever arm.

2. The stapler as claimed in claim 1 wherein the coupled member of the base assembly further includes a first connected hole and a second connected hole; wherein the lever arm further includes a first coupled orifice and a second coupled orifice defined between the first coupled orifice and the third slide grooves, with the magazine assembly pivotally joined to the base assembly at the first connected hole of the coupled member, and with the second connected hole of the coupled member pivotally connected to the second coupled orifice of the lever arm.

3. The stapler as claimed in claim 2 further comprising a hooked portion formed at the coupled member between the first and second connected holes and adapted to selectively engage with the lever arm.

4. The staple as claimed in claim 2 wherein each first slide groove has a first section and a second section, with the first and second sections forming an angle therebetween, with the first section of each first slide groove being approximately parallel to a longitudinal direction of the linkage assembly; wherein each first slide groove is L-shaped, with the lever arm slideably coupled to the first slide grooves via the first coupled orifice thereof; wherein during firing staples, the first coupled orifice is adjacent to the first section of the first slide grooves; wherein during filling staples, the first coupled orifice is adjacent to the second section of the first slide grooves.

5. The staple as claimed in claim 3 wherein each first slide groove has a first section and a second section, with the first and second sections forming an angle therebetween, with the first section of each first slide groove being approximately parallel to a longitudinal direction of the linkage assembly; wherein each first slide groove is L-shaped, with the lever arm slideably coupled to the first slide grooves via the first coupled orifice thereof; wherein during firing staples, the first coupled orifice is adjacent to the first section of the first slide grooves; wherein during filling staples, the first coupled orifice is adjacent to the second section of the first slide grooves.

6. The staple as claimed in claim 1 wherein each third slide groove has a first section and a second section; wherein during firing staples, the second slide grooves are adjacent to the first sections of the third slide grooves; wherein during filling staples, the second slide grooves are adjacent to the second sections of the third slide grooves.

7. The staple as claimed in claim 2 wherein each third slide groove has a first section and a second section; wherein during firing staples, the second slide grooves are adjacent to the first sections of the third slide grooves; wherein during filling staples, the second slide grooves are adjacent to the second section of the third slide grooves.

8. The staple as claimed in claim 3 wherein each third slide groove has a first section and a second section; wherein during firing staples, the second slide grooves are adjacent to the first section of the third slide grooves; wherein during filling staples, the second slide grooves are adjacent to the second sections of the third slide grooves.

9. The staple as claimed in claim 1 wherein the magazine assembly further includes a shell member and a magazine cover pivotally connected to the shell member and adapted to receive staples, with the second end of the linkage assembly being able to drive the magazine cover.

10. The staple as claimed in claim 9 wherein the firing member defines a slot and the magazine cover defines a hook portion engaged with the slot of the firing member.

11. The staple as claimed in claim 9 further comprising an elastic element having two first legs inserted into the magazine cover and a second leg tilting up with respect to the first legs in an original position of the stapler.

12. The staple as claimed in claim 1 further comprising several of joint units adapted to joined the base assembly, the magazine assembly, the linkage assembly and the lever arm to one another.
